(19) United States
(12) Patent Application Publication
(10) Pub. No.: US 2026/0266213 A1
(43) Pub. Date: Sep. 10, 2026

(54) DUCTED FUEL INJECTION STRATEGY EMPLOYING BAFFLE FOR REDIRECTION OF COMBUSTING FUEL PLUMES

(71) Applicant: Caterpillar Inc., Peoria, IL (US)

(72) Inventor: Russell P. Fitzgerald, Peoria, IL (US)

(73) Assignee: Caterpillar Inc., Peoria, IL (US)

(21) Appl. No.: 19/069,683

(22) Filed: Mar. 4, 2025

(51) Int. Cl. F02B 23/06; F02F 1/24

(52) U.S. Cl. CPC F02B 23/0651; F02B 23/0696; F02F 1/24

(57) ABSTRACT

A combustion system in an internal combustion engine system includes a cylinder head, a fuel injector supported in the cylinder head, and a plurality of spray ducts each arranged to duct a fuel spray jet from a respective one of the spray orifices. The combustion system also includes a baffle having at least one baffle surface extending between the cylinder head and the spray ducts to redirect a plurality of combusting spray plumes therefrom. Redirecting of the spray plumes aids in oxidation of particulate matter, namely soot, by way of limiting at least one of re-entrainment or quenching of the spray plumes.

### TECHNICAL FIELD

The present disclosure relates generally to ducted fuel injection, and more particularly to redirecting combusting fuel plumes in a ducted fuel injection combustion system to limit impingement upon a spray duct.

### BACKGROUND

Modern internal combustion engines include one or more cylinders each having an associated piston together forming a combustion chamber or cylinder. Fuel for combustion is admitted into the combustion chamber commonly by way of a fuel injector. Fuel injectors can be arranged as direct injectors directly injecting the fuel and extending into the combustion chamber, or as port-injectors or manifold-injectors, for example. Fuel injectors typically include several spray orifices, the opening and closing of which is controlled by way of a needle valve or similar component sometimes referred to as a check.

Depending upon fuel type, combustion of the fuel in the cylinder tends to produce a range of emissions in exhaust from the engine, some of which are considered undesirable. Many strategies are known for filtering, chemically reducing, or otherwise treating exhaust constituents to limit discharge in the exhaust. In recent years, there has been great interest in controlling and/or managing the manner and mechanisms of combustion in-cylinder in an effort to control the exhaust emissions profile of internal combustion engines so as to reduce or eliminate requirements for aftertreatment strategies.

Ducted fuel injection assemblies have been implemented in some engines to enhance mixing and reduce an amount of particulate matter, namely, soot, formed in a combustion chamber. Ducted assemblies typically include one or more tubular structures supported adjacent to the fuel injector by way of attachment to the cylinder head or to the fuel injector itself and positioned such that the ducts receive fuel spray jets from the fuel injector. The fuel spray tends to interact with the ducts to ultimately enhance mixing of the fuel with air, in particular by increasing the so-called “liftoff” length of the fuel spray jets to increase mixing of air with the plumes of fuel. One known ducted fuel injection application is set forth in U.S. Pat. No. 11,885,290 B2 to John et al. While known ducted injection strategies present great promise for reduced emissions operation, there is always room for development of improvements and alternatives.

### SUMMARY

In one aspect, a combustion system includes a cylinder head arranged to form, in part, a cylinder, and a fuel injector supported in the cylinder head and having a plurality of spray orifices formed therein. The combustion system further includes a baffle having at least one baffle surface extending between the cylinder head and the plurality of spray ducts to redirect a plurality of combusting spray plumes therefrom.

In another aspect, an engine system includes an engine having an engine housing with a cylinder formed therein, and including a cylinder head. The engine system further includes a fuel injector supported in the cylinder head, and a plurality of spray ducts arranged to duct a plurality of fuel spray jets from the fuel injector into the cylinder. The engine system also includes a baffle having at least one baffle surface extending between the cylinder head and the plurality of spray ducts to redirect a plurality of combusting spray plumes therefrom.

In still another aspect, a method of operating an engine includes ducting a plurality of spray jets of a fuel from a fuel injector through a plurality of spray ducts into a cylinder, and directing combusting spray plumes of the fuel outgoing from each of the plurality of spray ducts in reentrant paths through the cylinder head back toward the plurality of spray ducts. The method further includes redirecting the combusting spray plumes by way of a baffle in the cylinder so as to limit impingement of the combusting spray plumes upon the plurality of spray ducts.

### BRIEF DESCRIPTION OF DRAWINGS

FIG. 1 is a partially sectioned side diagrammatic view of an engine system, according to one embodiment;

FIG. 2 is a partially sectioned side diagrammatic view of a combustion system, according to one embodiment;

FIG. 3 is an elevational view of portions of a combustion system as in FIG. 2; and

FIG. 4 is a diagrammatic view of a combustion system, according to another embodiment.

### DETAILED DESCRIPTION

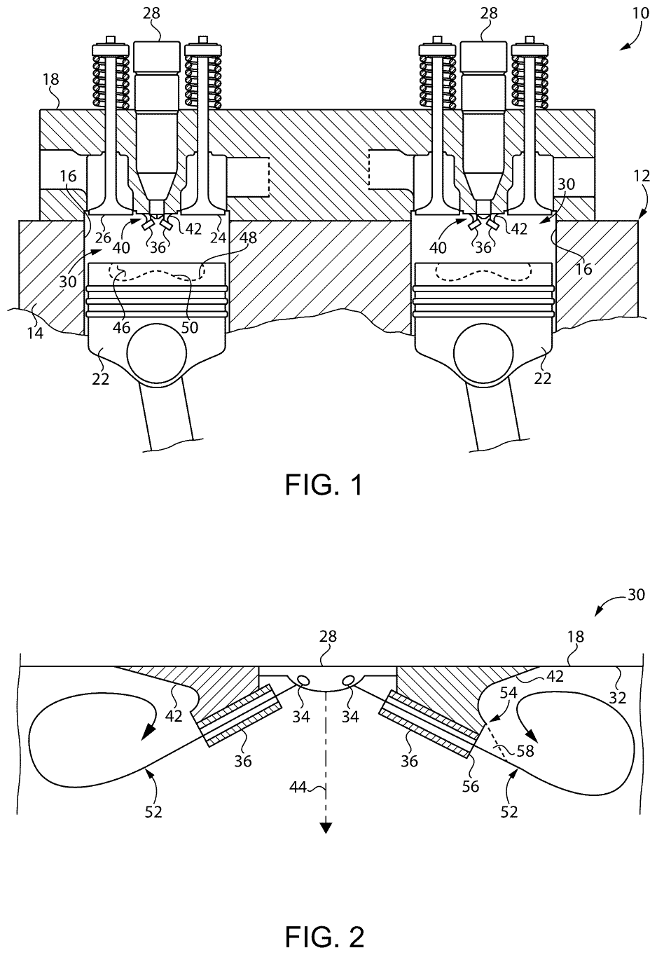

Referring to FIG. 1, there is shown an internal combustion engine system 10, according to one embodiment. Engine system 10 includes an internal combustion engine 12 having a cylinder block 17 with a plurality of cylinders 16 formed therein. A cylinder head 18 is attached to cylinder block 14. A plurality of pistons 22 are positioned in cylinders 16 and each movable in a generally conventional manner between a bottom-dead-center position and a top-dead-center position, typically in a four-stroke engine cycle. Cylinders 16 can include any number, in any suitable arrangement such as an inline pattern, a V-pattern, or still another. Each cylinder 16, hereinafter referred to, at times, in the singular, is associated with one or more intake valves 24 and one or more exhaust valves 26. Intake valve 24 and exhaust valve 26 open and close to provide admission of intake air for combustion, and expelling of exhaust, respectively.

Engine 12 may be compression-ignited, such that pistons 22 are movable to increase a pressure and temperature within the respective cylinder 16 to an autoignition threshold for a directly injected compression-ignition fuel. Suitable fuels can include a diesel fuel, such as a diesel distillate fuel, or lower cetane fuels blended with a cetane enhancer, for example. Engine 12 further includes a plurality of fuel injectors 28 each arranged as direct injectors extending partially into a respective cylinder 16. Fuel injectors 28 may be electronically controlled and hydraulically actuated. Engine system 10 can be applied for any known purpose including operating a driveline in a land vehicle or a marine vessel, or powering a pump, a compressor, or an electrical generator, to name a few examples.

Referring also now to FIG. 2, components of engine system 10 may be arranged to form a combustion system 30. Combustion system 30 includes a cylinder head 18 arranged to form, in part, a cylinder 16. In the illustrated embodiment cylinder head 18 forms, in part, a plurality of cylinders 16. Cylinders 16, referred to hereinafter, at times, in the singular, can include any number in any suitable arrangement such as an inline pattern, a V-pattern, or still another. Combustion system 30 also includes a fuel injector 28, typically one of a plurality of fuel injectors, supported in cylinder head 18 and having a plurality of spray orifices 34 formed therein. Cylinder head 18 includes a fire deck 32 exposed to cylinder 16. Spray orifices 34 can be opened and closed in a generally conventional manner to inject fuel spray jets of pressurized fuel from each respective one thereof. A number of spray orifices 34 may be at least two, and commonly, three, four, five, or potentially more. Those skilled in the art will be familiar with internal fuel injector components and operations to selectively inject a fuel for combustion at a desired injection timing.

Combustion system 30 may further include one or more pistons 22 as listed above. Piston 22, also referred to hereinafter, at times, in the singular, includes a combustion bowl 46. Combustion bowl 46 may have a reentrant profile. A bowl floor is shown at numeral 50 and transitions to a bowl outer wall 48. Utilizing a reentrant combustion bowl can assist, as further discussed herein, in directing combusting spray plumes of fuel in reentrant paths through cylinder 16.

Combustion system 30 further includes a plurality of spray ducts 36 each arranged to duct a fuel spray jet from a respective one of spray orifices 34. Combustion system 30 also includes a baffle 40 including at least one baffle surface 42 extending between cylinder head 18 and spray ducts 36 to redirect a plurality of combusting spray plumes from spray ducts 36.

Spray ducts 36 may be attached to fire deck 32, to fuel injector 28, or potentially to both, and each arranged in spray path alignment with a respective one of spray orifices 34 to receive an outgoing spray jet of fuel. As can be seen from FIG. 2, each of spray ducts 36 defines a combusting spray plume path 52. The at least one baffle surface 42 may define a spray plume deflection angle 54 relative to the respective outgoing plume path 52. In the illustrated embodiment plume deflection angle 54 opens generally radially inward in a direction of a center axis 44 defined by fuel injector 28 and axially upward. It can be noted from the illustration of FIG. 2 that spray plume path 52 is generally curved by way of impingement upon baffle surface 42 so as to avoid directly impinging upon spray duct 36.

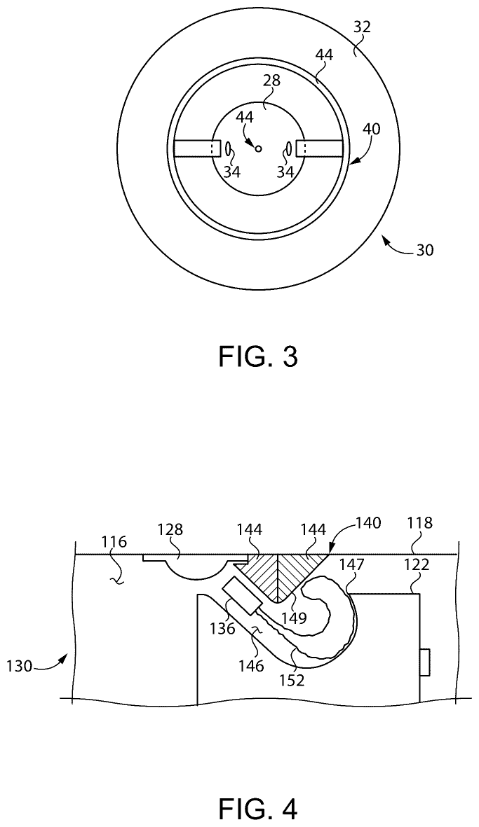

Each of spray ducts 36 extends to a duct distal tip 56. Baffle surface 42 may define a plume disengagement location 58 that is aligned with, in a radial direction, or located distally to, the respective duct distal tip 56. As can also be noted from FIG. 2 baffle surface 42 is at least partially curvilinear and may be entirely curvilinear providing a curved profile path for guiding spray plume 52. Also in the illustrated embodiment baffle surface 42 may be understood as concave curvilinear and extends circumferentially around center axis 44. Referring also to FIG. 3, there can be seen the annular shape of baffle 40 and the full circumferential extent of baffle surface 42. Baffle 40 itself may serve to support spray ducts 36 in cylinder 36 such as by way of attachment to cylinder head 18 so as to support and align spray ducts 36 in orientations for service in combustion system 30. In other embodiments, further discussed herein, more than one baffle surface and more than one individual baffle element may be utilized.

Referring now to FIG. 4, there is shown a combustion system 130 according to another embodiment. Combustion system 130 includes a piston 122, a fuel injector 128 supported in a cylinder head 118, and a baffle 140. Piston 122 includes a combustion bowl 146. One of a plurality of spray ducts 136 is shown in FIG. 4 as it might appear ducting an outgoing spray jet from fuel injector 128 to form a combusting spray plume 152. Plume 152 advances outwardly of spray duct 136 and is directed in a reentrant path through a cylinder 116 upwardly and back toward spray duct 136. As plume 152 is directed back toward spray duct 136 in the reentrant path it will impinge upon baffle 140.

Baffle 140 may include a plurality of baffle surfaces 144. In the illustrated embodiment baffle 140 may have a leading impingement edge 149 that is impinged upon by plume 152 and causes plume 152 to separate or split and advance in directions avoiding impingement upon spray duct 136, generally in opposite directions circumferentially around a center axis of fuel injector 128. Baffle 140 may be one of a plurality of individual baffle elements each secured to cylinder head 118 and spaced circumferentially around fuel injector 128. Baffle element 140 may have a pyramidal shape, a concave shape, a convex shape, or still another shape so long as one or more baffle surfaces 144 and potentially also impingement edge 149 is positioned to interact with plume 152 to limit re-entrainment of plume 152 and/or impingement upon spray duct 136.

### INDUSTRIAL APPLICABILITY

Referring to the drawings generally, but returning focus to the embodiment of FIG. 2, operating engine 12 can include ducting a plurality of spray jets of a fuel from fuel injector 28 through the plurality of spray ducts 36 into a cylinder. Combusting spray plumes of the fuel outgoing from each of spray ducts 36 may be directed in reentrant paths through cylinder 16 ultimately back toward spray ducts 36. The combusting plumes may be redirected by way of baffle 40 in cylinder 16 so as to limit impingement of the combusting plumes upon spray ducts 36. As discussed herein, redirecting of the combusting plumes may also limit the extent of which plumes are re-entrained. As also discussed herein piston 22 cooperates in directing the combusting plumes. Baffle 40 may also limit cooling and/or quenching of the combusting plumes based on the redirecting thereof such as might occur by way of contact between the fuel and spray ducts 36.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A combustion system comprising:
a cylinder head arranged to form, in part, a cylinder;
a fuel injector supported in the cylinder head and having a plurality of spray orifices formed therein;
a plurality of spray ducts each arranged to duct a fuel spray jet from a respective one of the plurality of spray orifices; and
a baffle including at least one baffle surface extending between the cylinder head and the plurality of spray ducts to redirect a plurality of combusting spray plumes therefrom.

2. The combustion system of claim 1 wherein each of the plurality of spray ducts defines a combusting spray plume path, and the at least one baffle surface defines a spray plume deflection angle relative to the outgoing spray plume paths.

3. The combustion system of claim 2 further comprising a piston having a reentrant combustion bowl, and each of the combusting spray plume paths targets a surface of the combustion bowl.

4. The combustion system of claim 2 wherein each of the plurality of spray ducts extends to a duct distal tip, and the at least one baffle surface defines a plume disengagement location that is aligned with or distal to the respective duct distal tip.

5. The combustion system of claim 1 wherein the at least one baffle surface is at least partially curvilinear.

6. The combustion system of claim 5 wherein the at least one baffle surface is concave curvilinear.

7. The combustion system of claim 6 wherein the at least one baffle surface extends circumferentially around the center axis.

8. The combustion system of claim 1 wherein the at least one baffle surface includes a plurality of baffle surfaces.

9. The combustion system of claim 8 wherein the baffle includes a plurality of baffle elements extending downwardly from the cylinder head and including the respective plurality of baffle surfaces.

10. The combustion system of claim 9 wherein the plurality of baffle elements each include an impingement edge oriented for impingement via one of the plurality of combusting plumes.

11. The combustion system of claim 1 wherein the baffle is annular and supports the plurality of spray ducts in the cylinder.

12. An engine system comprising:
an engine including an engine housing having a cylinder formed therein, and including a cylinder head;
a fuel injector supported in the cylinder head;
a plurality of spray ducts arranged to duct a plurality of fuel spray jets from the fuel injector into the cylinder; and
a baffle including at least one baffle surface extending between the cylinder head and the plurality of spray ducts to redirect a plurality of combusting spray plumes therefrom.

13. The engine system of claim 12 further comprising a piston in the cylinder and forming a combustion bowl having an outer bowl surface oriented to guide the plurality of combusting spray plumes upwardly and inwardly in the cylinder toward the at least one baffle surface.

14. The engine system of claim 12 wherein the baffle is annular and supports the plurality of spray ducts in the cylinder.

15. The engine system of claim 12 wherein the at least one baffle surface extends circumferentially around a center axis of the fuel injector.

16. The engine system of claim 12 wherein the at least one baffle surface is concave curvilinear.

17. The engine system of claim 12 wherein the baffle includes a plurality of baffle elements extending downwardly from the cylinder head, and the at least one baffle surface includes a plurality of baffle surfaces upon the respective plurality of baffle elements.

18. A method of operating an engine comprising:
ducting a plurality of spray jets of a fuel from a fuel injector through a plurality of spray ducts into a cylinder;
directing combusting spray plumes of the fuel outgoing from each of the plurality of spray ducts in reentrant paths through the cylinder back toward the plurality of spray ducts; and
redirecting the combusting plumes by way of a baffle in the cylinder so as to limit impingement of the combusting plumes upon the plurality of spray ducts.

19. The method of claim 18 wherein the directing combusting spray plumes of the fuel includes directing the combusting spray plumes by way of a combustion bowl of a piston, and further comprising limiting at least one of re-entrainment or quenching of the combusting spray plumes based on the redirecting thereof.

20. The method of claim 18 wherein the limiting impingement includes limiting impingement by way of at least one baffle surface of the baffle that is concave curvilinear.
